(19) United States
(12) Patent Application Publication
(10) Pub. No.: US 2015/0103702 A1
(43) Pub. Date: Apr. 16, 2015

(54) FRAME FORMAT IN COMMUNICATIONS

(71) Applicants: Eeva Lahetkangas, Oulu (FI); Esa Tapani Tiirola, Kempele (FI); Kari Pekka Pajukoski, Oulu (FI)

(72) Inventors: Eeva Lahetkangas, Oulu (FI); Esa Tapani Tiirola, Kempele (FI); Kari Pekka Pajukoski, Oulu (FI)

(73) Assignee: Nokia Solutions and Networks Oy, Espoo (FI)

(21) Appl. No.: 14/389,606

(22) PCT Filed: Apr. 3, 2012
(86) PCT No.: PCT/EP2012/056054

§ 371 Date: Sep. 30, 2014

(51) Int. Cl. H04L 5/16; H04L 5/14

(52) U.S. Cl. CPC H04L 5/16; H04L 5/1438
USPC 370/280

(57) ABSTRACT

A method for selecting a frame format in a communications system is disclosed. A network apparatus (AP) predefines a TDD data frame structure such that a TDD frame has a predefined frame duration defining an uplink-downlink switching point periodicity. The frame duration defines a maximum time in which a half-duplex apparatus performs a cycle transmit-receive-transmit and/or a cycle receive-transmit-receive. An uplink-downlink ratio is adjustable on a symbol level in the TDD frame. The TDD frame is partitioned into one or more of a guard period, a downlink portion and an uplink portion.

### FIELD OF THE INVENTION

The exemplary and non-limiting embodiments of this invention relate generally to wireless communications networks, and more particularly to frame format selection.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Full duplex refers to a capability of simultaneous two-way and independent transmissions in both directions (i.e. transmission and reception). Typically, FDD (frequency division duplex) systems are capable of full duplex operation. Time division duplex (TDD) refers to a duplex in which several signals are interleaved in time for transmission over a common frequency channel. In TDD, the same frequency channel may be used for transmission in both directions. In practical realizations, TDD systems are realized by means of a half duplex principle wherein both ends of a bidirectional connection alternate between transmitting and receiving bursts of data. This means that tx/rx nodes are not able to perform transmission and reception simultaneously.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise a method, an apparatus, a user equipment and a computer program product as defined in the independent claims. Further embodiments of the invention are disclosed in the dependent claims.

An aspect of the invention relates to a method for selecting a frame format in a communications system, the method comprising predefining, in a communications apparatus, a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of a guard period, a link direction 2 portion and a link direction 1 portion.

A further aspect of the invention relates to an apparatus comprising at least one processor, and at least one memory including a computer program code, wherein the at least one memory and the computer program code are configured to, with the at least one processor, cause the apparatus to predefine, a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of a guard period, a link direction 2 portion and a link direction 1 portion.

A still further aspect of the invention relates to a user equipment comprising at least one processor, and at least one memory including a computer program code, wherein the at least one memory and the computer program code are configured to, with the at least one processor, cause the user equipment apply a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of a guard period, a link direction 2 portion and a link direction 1 portion.

A still further aspect of the invention relates to a computer program product comprising program code means adapted to perform any one of the method steps when the program is run on a computer.

Thus the frame structure disclosed enables a fast time division duplex (TDD) access and fully flexible UL/DL switching.

### BRIEF DESCRIPTION OF THE DRAWINGS

FIG. 1 illustrates a frame structure type 2;

FIG. 2 illustrates a flexible UL/DL structure proposal in LTE Release-11;

FIG. 3 illustrates frame structures of normal and special frames according to an exemplary embodiment;

FIG. 4 illustrates dynamic UL/DL ratio adjustment according to an exemplary embodiment;

FIG. 5 illustrates a hierarchical frame structure according to an exemplary embodiment;

FIG. 6 shows a simplified block diagram illustrating exemplary system architecture;

FIG. 7 shows a simplified block diagram illustrating exemplary apparatuses;

FIG. 8 shows a messaging diagram illustrating an exemplary messaging event according to an embodiment of the invention;

FIG. 9 shows a schematic diagram of a flow chart according to an exemplary embodiment of the invention;

FIG. 10 shows a schematic diagram of a flow chart according to another exemplary embodiment of the invention;

FIG. 11 illustrates a flexible location of a protected part in a frame according to an exemplary embodiment;

FIG. 12 illustrates a location of a guard period in a frame according to an exemplary embodiment;

FIGS. 13 and 14 illustrate a location of two protected parts in a frame according to an exemplary embodiment.

### DETAILED DESCRIPTION OF SOME EMBODIMENTS

An exemplary embodiment relates to a future beyond-4G (B4G) radio system. It may, however, also be introduced in an evolution of LTE within any new release. A specific use case is over-the-air discovery and direct data communication with LTE D2D. The focus is especially on time division duplex (TDD) in a local area optimized radio system.

In a B4G radio system, tight latency requirements of ˜1 ms may set tight targets for round trip time (RRT), causing also faster UL/DL switching time requirements. The current latency hard limits related to LTE-advanced (DL-UL-DL cycle with a 5 ms minimum limit) are not sufficient for B4G systems. In order to achieve faster UL/DL switching and a flexible UL/DL switching ratio, modifications to physical frame structure and current LTE-advanced TDD radio are needed.

Unlike the wide area cellular system, a local area system may utilize local-access-only frequency band including classical operator deployment and shared spectrum use, the license-exempt spectrum or white spaces to take advantage of additional available bandwidth. In addition, the local area system enables offering an efficient device-to-device operation mode to establish ad-hoc networks.

In frequency division duplex (FDD) LTE and LTE-advanced, the radio frame structure is optimized for wide area scenario. This is visible, for example, in the frame structure's cyclic prefix length, reference signal density, TTI length, OFDM symbol length, and so on. Time division duplex (TDD) LTE frame is built on the top of LTE frame structure type 2. Since in most cases the FDD solution is just copied to the TDD size, and the TDD specific changes are minimized, there is not too much TDD optimization in the current TD-LTE.

Due to unavailable simultaneous UL/DL in TDD systems (half-duplex), downlink (DL)-uplink (UL) switching with certain switching timings need to be implemented. In TDD LTE, uplink-downlink configurations with both 5 ms and 10 ms downlink-to-uplink switch-point periodicity are supported. The available uplink-downlink configurations for TD-LTE are presented in Table 1. It can be seen that the link direction (UL→DL, DL→UL) may be switched at maximum twice per 5 ms and one DL-UL-DL cycle may happen only once within the 5 ms switching time. This UL-DL switching restriction may be seen as a hard limit for the latency in LTE, and it is clearly far too slow for B4G latency requirements.

TABLE 1
Uplink-downlink configurations in TDD-LTE

| UL-DL | Switching- | | | | | | | | | | |
|---|---|---|---|---|---|---|---|---|---|---|---|
| config- | point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Latency is a specific challenge with (half-duplex) TDD. This can be seen also in TD-LTE in which the latency performance is clearly worse compared to FDD and varies according to link direction, UL/DL configuration and subframe number. In FDD side, the air-interface latency is fairly constant with the comparable number of HARQ re-transmission.

Another challenge related to the current TDD-LTE radio frame structure is that UL/DL switching ratio may only be adjusted in a limited manner. As can be seen from Table 1, the UL activity may only be adjusted between 20% and 60% (discarding UpPTS). Ideally, UL/DL traffic adaptation may be fully dynamic without any limitation in the UL/DL ratio.

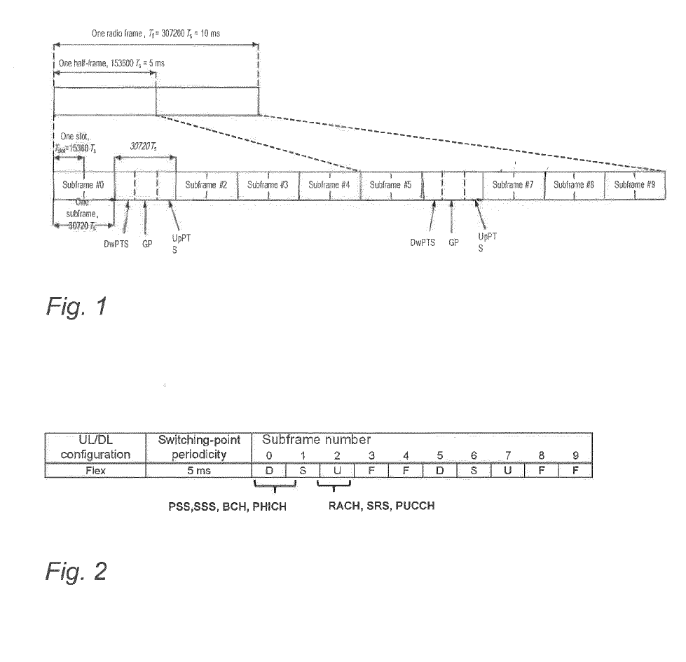

LTE-advanced TDD frame structure has a so called special subframe with three fields (DwPTS, GP and UpPTS) in a predefined position. The radio frame structure used in LTE/LTE-advanced TDD is described in TS 36.211 V10.4, chapter 4.2. According to TS 36.211 V10.4, chapter 4.2, frame structure type 2 is applicable to TDD, wherein each radio frame of length T_{f}=307 200·Tₛ=10 ms consists of two half-frames of length 153 600·Tₛ=5 ms each. Each half-frame consists of five subframes of length 30 720·Tₛ=1 ms. Supported uplink-downlink configurations are listed in Table 3 where, for each subframe in a radio frame, “D” denotes that the subframe is reserved for downlink transmissions, “U” denotes that the subframe is reserved for uplink transmissions, and “S” denotes a special subframe with the three fields DwPTS, GP and UpPTS. The length of DwPTS and UpPTS is given by Table 2 subject to the total length of DwPTS, GP and UpPTS being equal to 30 720·Tₛ=1 ms. Each subframe i is defined as two slots, 2i and 2i+1 of length Tₛₗₒₜ=15 360·Tₛ=0.5 ms in each subframe. Uplink-downlink configurations with both 5 ms and 10 ms downlink-to-uplink switch-point periodicity are supported. In case of 5 ms downlink-to-uplink switch-point periodicity, the special subframe exists in both half-frames. In case of 10 ms downlink-to-uplink switch-point periodicity, the special subframe exists in the first half-frame only. Subframes 0 and 5 and DwPTS are always reserved for downlink transmission. UpPTS and the subframe immediately following the special subframe are always reserved for uplink transmission. In case multiple cells are aggregated, UE may assume the same uplink-downlink configuration across all the cells and that the guard period of the special subframe in the different cells have an overlap of at least 1456·Tₛ. FIG. 1 illustrates the frame structure type 2 (for 5 ms switch-point periodicity).

TABLE 2
Configuration of a special subframe (lengths of DwPTS/GP/UpPTS)

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

TABLE 3
Uplink-downlink configurations

| Uplink-downlink | Downlink-to-Uplink | Subframe number | | | | | | | | | |
|---|---|---|---|---|---|---|---|---|---|---|---|
| configuration | switch-point periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In LTE-TDD, switching between UL and DL modes occurs in the time scale of multiple subframes. LTE-TDD does not support efficient fast switching between UL and DL modes within a single subframe. Furthermore, changing the TDD configuration is very slow due to the fact that it is part broadcasted system information. A (sub)frame structure allowing fully dynamic UL/DL switching among “UL only”, “DL only” “DL and UL” subframes has been presented, wherein the selection of the frame format is carried out dynamically based on instantaneous data transmission requirements and control signals transmitted between the sending and receiving transceivers. However, that solution does not provide robust signalling for the most critical control signals.

FIG. 2 illustrates a flexible UL/DL structure in LTE Release-11. The proposal for flexible UL/DL allocation as presented in FIG. 2 can be seen as a UL/DL configuration (‘flex UL/DL’) where certain subframes (3, 4, 8 and 9) are subjected to flexible UL/DL switching. Common channels and most critical control signals may be kept free from cross-link interference by allocating them to the non-flexible subframes of the frame. That proposal, however, has some limitations, for example, UL/DL flexibility is limited to part of the subframes.

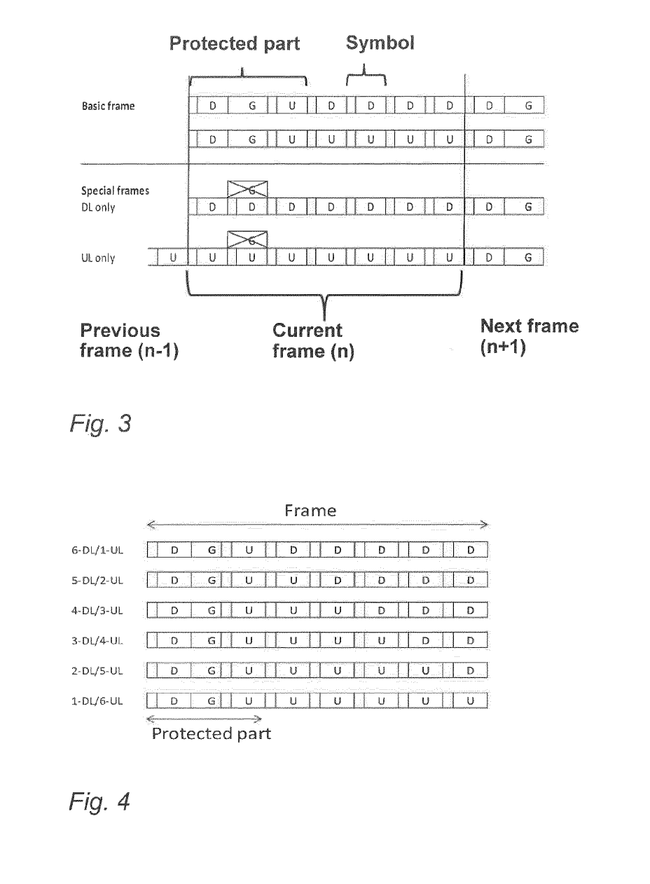

An exemplary embodiment proposes a TDD frame structure which supports fast UL/DL switching and fully flexible UL/DL ratio. An exemplary embodiment provides a low-latency solution for the TDD system with fast UL/DL switching and a flexible UL/DL ratio on top of framed access. FIG. 3 illustrates frame structures of proposed normal and special frames. An exemplary embodiment shown in FIG. 3 comprises a frame structure with predefined duration, predefined partitioning (including guard period, downlink portion and uplink portion) and flexible UL/DL ratio that may be adjusted at a symbol level.

It should be noted that the guard period in an exemplary embodiment of FIG. 3 has been illustrated only in single place (between DL and UL portion). However, in practise the guard period may also be needed in between UL and DL portions. It has been assumed that the system has sufficient capability to share the guard period into two portions (DL→UL) and (UL→DL). This may be carried out as part of an UL timing advanced procedure and/or there may be a parameter that defines a (minimum) length for at least one of the guard period portion(s). Another notion is that FIG. 3 has been illustrated from a traditional AP/eNB←→UE communication point of view (→link directions, UL and DL are well defined). However, it should be noted that the link directions may not be similarly defined in the case of D2D or AP2AP communications in which an exemplary embodiment is equally valid. For such purposes, proper modifications for illustration of the frame structure may be needed. For example, DL and UL may be illustrated by means of “transmit” and “receive” phases. Tx and Rx phases are opposite for two network nodes (source and destination nodes) part of data transfer.

It should be understood that various modifications related to FIG. 3 (and the other figures as well) are within the scope of an exemplary embodiment. One such modification is that “D” and “U” are just swapped. In this kind of versions the first UL portion is at the beginning of the subframe. Another modification is such that UL and DL are placed at both ends of the subframe (e.g. such that DL is at the beginning of frame, and UL is at the end of the frame) whereas the placement of the guard portion is made flexible. In this modification, the protected part may be divided into two portions of the frame, namely DL portion and UL portion.

An exemplary embodiment discloses a frame structure with 1) predefined frame duration defining the switching point periodicity (in other words, frame length defines a maximum time in which the half-duplex equipment performs the cycle: tx-rx-tx or rx-tx-rx), 2) predefined partitioning of the frame comprising a guard period (GP) and DL and UL portions, and/or 3) predefined partitioning of the frame into protected and non-protected parts.

The DL portion may be divided into two parts, and the first DL portion (with the exception of “UL only” special frame format) is located at the beginning of the frame. The first DL portion is followed by the guard period that is then followed by the UL portion.

The UL portion (with the exception of “DL only” special frame format) may also be divided into two parts and the parts are sent subsequently (note that DL portions are not sent subsequently). The second part of DL portion is located after the UL portion at the end of the frame. Protected part of the frame comprises the first DL portion, guard period and the first UL portion. Non-protected part comprises the second UL portion (optional, depends on the UL/DL configuration) and the second DL portion (optional, depends on the UL/DL configuration).

According to an exemplary embodiment, protected part of the frame may be configured in a semi-static manner, whereas the UL/DL ratio on the remaining non-protected part of the frame may be configured dynamically by setting it adaptively in a symbol-specific manner.

According to an exemplary embodiment, special frame formats “UL only” and “DL only” are defined. These frames only comprise UL or DL portions, wherein no guard period is included in the frame structure.

According to an exemplary embodiment, scalable frame duration may be used to allow trade-off between GP overhead and latency.

According to an exemplary embodiment, scalable GP length may be used to allow trade-off between GP/timing advance requirements and latency.

According to an exemplary embodiment, a hierarchical frame solution with local frames within a master frame may be used to achieve faster and more flexible UL/DL switching. The normal frame format used by the net-work/cell (and AP) may be called a master frame. UL/DL division of the protected part of the master frame needs to be followed by each node (UE/AP) in the cell. However, if during the unprotected part of the master frame there is no other data transmission of higher priority, the unprotected part of the frame may be divided to local frames suitable for some lower priority connection. The principles of the local frame structure are the same as for the master frame, thus there is a local frame specific DL portion, guard period and UL portion.

According to an exemplary embodiment, the proposed format is applied on top of LTE frame structure. Frame length is defined to be 1 ms (or 0.5 ms). eNB may have a capability to schedule/assign the proposed format replacing a current subframe (or slot). The scheduling may relate to one or more consecutive subframes (or slots). The scheduling may be carried out dynamically or semi-statically and it may be based on a predefined pattern of subframes (or slots). The usage of the proposed format may be limited to certain specific use cases, e.g. D2D.

An exemplary embodiment provides a low-latency solution for TDD on top of framed access. This may be achieved based on a TDD-based radio system where a first transceiver (eNB or AP) selects an applied frame format, configures the transmission and reception accordingly, and signals the selected frame format to at least one second transceiver (UE). The second transceiver receives information on the selected (sub)frame format, and configures the transmission and reception accordingly.

According to an exemplary embodiment, the applied frame format is configured semi-statically or selected dynamically based on an instantaneous need for transmitting UL/DL data and control signals between the first transceiver and at least one second transceiver. The same procedure may also be used in device-to-device (D2D) type of communication.

The proposed frame structure solution presented in FIG. 3 comprises a normal frame structure with following properties:

1. Predefined frame duration defining the switching point periodicity:
frame duration defines the switching time periodicity, i.e. the maximum time between the cycle transmit-receive-transmit (or receive-transmit-receive).
scalable frame length may be used to allow trade-off between GP overhead and latency; increasing the switching point periodicity (that is decreasing the frame length) allows more frequent DL→UL switching but increases the relative GP overhead.
scalable GP length may be used to allow trade-off between GP and timing advance requirements and latency; decreasing the GP length allows more frequent DL→UL switching and results in improved latency. However, minimizing the GP length makes it difficult to utilize GP for data transmission (e.g. using DL-only/UL-only frames).
if GP is always included in the frame, GP length may easily be optimized to minimize the GP overhead.
in case it is possible that GP is not included in all the frames (“UL only” and “DL only” frames are used), GP length may be equal to the symbol length which enables that GP overhead is present only when needed.

2. Normal frame structure comprises symbols in DL portion, a guard period, and symbols in UL portion:
DL portion exists in frames with the exception of “UL only” special frame format, and it is divided into two parts; the first DL portion is located at the beginning of the frame, thus possible DL part precedes the UL part; the length of the first portion may be configured according to the use case; the second part of DL portion is located after the UL portion at the end of the frame.
guard period exists in frames with the exception of “UL only” and “DL only” special frame formats, it is located after the first DL portion; the length of the guard period may be configured according to the use case (depending e.g. on the cell size and the UL/DL switching time).
UL portion exists in frames with the exception of “DL only” special frame format, and it is divided into two parts; the two UL portion are sent subsequently after the guard period.

3. Frame is divided into protected and non-protected parts:
protected part includes the first DL portion, guard period and the first UL portion.
non-protected part includes the second UL portion and the second DL portion (or one of those in case of “UL only” and “DL only” special frame formats); the non-protected part is optional in the frame structure.

4. The UL/DL ratio of the non-protected part may be set adaptively in symbol specific manner. Protected part of the frame is outside the dynamic UL/DL ratio adjustment (it is configured in semi-static manner):
there are no restrictions on the UL/DL ratio adjustment within the non-protected part of the frame; FIG. 4 illustrates dynamic UL/DL ratio adjustment, giving examples of the UL/DL ratio scenarios of a normal frame of length 7 OFDMA symbols; the protected part of the frame remains the same, whereas the ratio of UL and DL portions in non-protected part may be varied from no UL symbols and all DL symbols to all UL symbols and no DL symbols.
UL/DL ratio may be set semi-statically or dynamically in frame-by-frame basis.

In addition to a normal frame format, two special frame formats, “UL only” and “DL only” may be defined. “UL only” format may be allocated in the case the current frame does not contain any DL signalling. In this format, only UL portion is included in the frame structure. “DL only” format may be allocated in the case the current frame does not contain any UL signalling. In this format only DL portion is included in the frame structure. Thus, these special frame formats do not contain guard period or the protected part. In addition, “UL only” frame format may be used only if the previous frame did not contain second DL portion at the end of the frame.

By using the proposed frame structure, most critical UL/DL signalling may be kept free from cross-link interference, assuming that the system is synchronized and the usage of “UL only” and “DL only” formats is coordinated.

A hierarchical frame solution with “local frames” within “a master frame” may be used in order to achieve more flexible UL/DL switching, for example, in device-to-device (D2D) type of communication. The basic normal frame format used by the network/cell is called a master frame. UL/DL division of the protected part of the master frame (location determined switching point periodicity) needs to be followed by each node in the network, and since it has full UL/DL protection, it is used to transmit most critical control signalling. Autonomous D2D may be prevented during protected portion. However, if during the unprotected part of the master frame there is no other data transmission of higher priority (for example, to/from access point), the unprotected part of the frame may be divided to local frames suitable for some lower priority connection (for example, D2D communication with another UE). Another option is that eNB configures predefined frames for autonomous D2D operation.

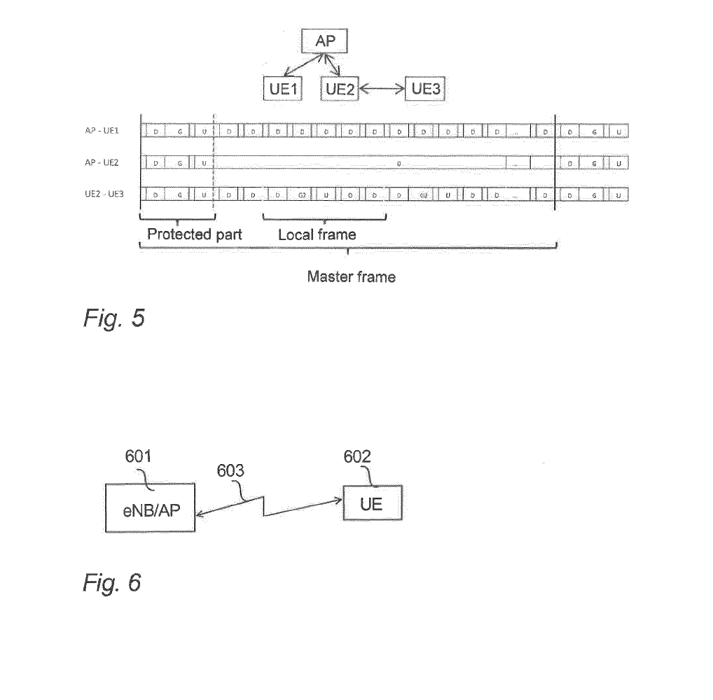

The principles of the local frame structure are the same as for the master frame, thus there is local frame specific DL portion, guard period and UL portion. The UL/DL ratio within the local frame may be adjusted to suit the needs of the particular local connection. Possible use case scenarios for the local frame include, for example, fast access, secondary spectrum usage, ready-to-send/clear-to-send (RTS/CTS) signalling, sounding and control signalling. FIG. 5 illustrates a hierarchical frame structure according to an exemplary embodiment. The concept of hierarchical frames demonstrated in FIG. 5 shows an active data connection determined by the master frame between an access point (AP) and a user equipment (UE1). There is shown an association but no active data transmission between AP and UE2, and a need to send and receive data between UE2 and UE3 with UL/DL switching requirements different from those determined by the master frame.

The frame structure an exemplary embodiment supports:
fast UL/DL switching; for example, GP length of 20 μs (2×10 μs) allows true ms-level RTT for a TDD-based system;
a fully flexible UL/DL ratio with symbol level adjustment;
possibility to use scalable frame duration and GP length to trade-off between latency and GP overhead & timing alignment requirements;
possibility to use local frame structures different from a master frame structure used throughout the cell, for example, in D2D communications.

The proposed arrangement may be seen as an enabler for D2D device discovery on top of the LTE system. The principle is compatible with the existing TD-LTE.

Exemplary embodiments will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, network node, server, corresponding component, and/or to any communication system or any combination of different communication systems that support TDD access. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE (long term evolution) network elements, without restricting the embodiment to such an architecture, however. The embodiments described in these examples are not limited to the LTE radio systems but can also be implemented in other radio systems, such as UMTS (universal mobile telecommunications system), GSM, EDGE, WCDMA, bluetooth network, WLAN or other fixed, mobile or wireless network. In an embodiment, the presented solution may be applied between elements belonging to different but compatible systems such as LTE and UMTS.

A general architecture of a communication system is illustrated in FIG. 6. FIG. 6 is a simplified system architecture only showing some elements and functional entities, all being logical units whose implementation may differ from what is shown. The connections shown in FIG. 6 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not to be discussed in more detail here.

The exemplary radio system of FIG. 6 comprises a network node 601 of a network operator. The network node 301 may include e.g. an LTE (or LTE-A) base station (eNB), base transceiver station (BS, BTS), access point (AP), radio network controller (RNC), mobile switching centre (MSC), MSC server (MSS), mobility management entity (MME), gateway GPRS support node (GGSN), serving GPRS support node (SGSN), home location register (HLR), home subscriber server (HSS), visitor location register (VLR), or any other network element, or a combination of network elements. The network node 601 may be connected to one or more further network elements via an interface (not shown in FIG. 6). In FIG. 6, the radio network node 601 that may also be called eNB (enhanced node-B, evolved node-B) of the radio system hosts the functions for radio resource management in a public land mobile network. FIG. 6 shows one or more user equipment 602 located in the service area of the radio network node 601. The user equipment refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 6, the user equipment 602 is capable of connecting to the radio network node 601 via a connection 603.

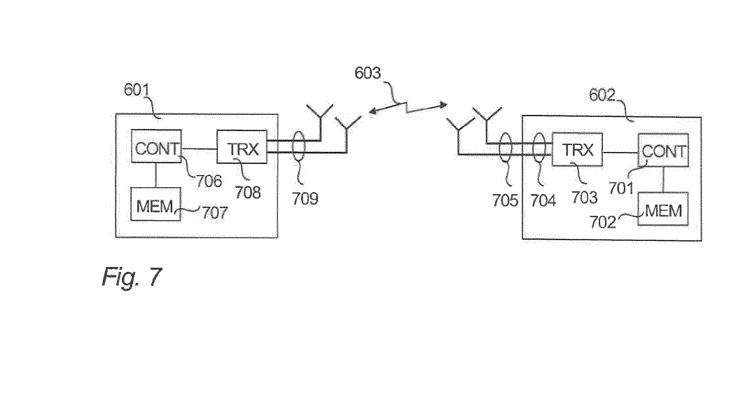

FIG. 7 is a block diagram of an apparatus according to an embodiment of the invention. FIG. 7 shows a user equipment 602 located in the area of a radio network node 601. The user equipment 602 is configured to be in connection with the radio network node 601. The user equipment or UE 602 comprises a controller 701 operationally connected to a memory 702 and a transceiver 703. The controller 701 controls the operation of the user equipment 602. The memory 702 is configured to store software and data. The transceiver 703 is configured to set up and maintain a wireless connection 603 to the radio network node 601. The transceiver is operationally connected to a set of antenna ports 704 connected to an antenna arrangement 705. The antenna arrangement 705 may comprise a set of antennas. The number of antennas may be one to four, for example. The number of antennas is not limited to any particular number. The user equipment 602 may also comprise various other components, such as a user interface, camera, and media player. They are not displayed in the figure due to simplicity. The radio network node 601, such as an LTE (LTE-A) base station (eNode-B, eNB) or access point (AP), comprises a controller 706 operationally connected to a memory 707, and a transceiver 708. The controller 706 controls the operation of the radio network node 601. The memory 707 is configured to store software and data. The transceiver 708 is configured to set up and maintain a wireless connection to the user equipment 602 within the service area of the radio network node 601. The transceiver 708 is operationally connected to an antenna arrangement 709. The antenna arrangement 709 may comprise a set of antennas. The number of antennas may be two to four, for example. The number of antennas is not limited to any particular number. The radio network node 601 may be operationally connected (directly or indirectly) to another network element (not shown in FIG. 7) of the communication system, such as a radio network controller (RNC), a mobility management entity (MME), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server. The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 601, 602 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 601, 602 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 702, 707 may include volatile and/or non-volatile memory and typically stores content, data, or the like. For example, the memory 702, 707 may store computer program code such as software applications (for example for the detector unit and/or for the adjuster unit) or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

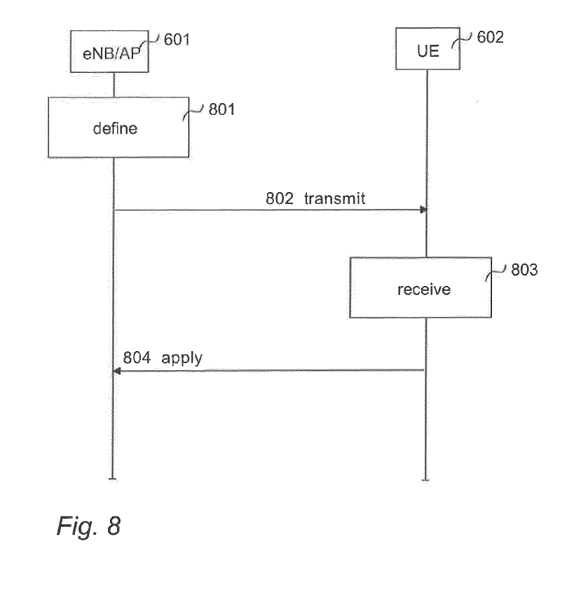

The signalling chart of FIG. 8 illustrates the required signalling. In the example of FIG. 8, a network apparatus 601 (which may comprise e.g. an LTE-capable (or LTE-A-capable) base station (eNode-B) or a WLAN access point (AP)) predefines, in item 801, a TDD data frame structure such that a TDD frame has a predefined frame duration defining an uplink-downlink switching point periodicity. Thus the frame duration defines a maximum time in which a half-duplex apparatus performs a cycle transmit-receive-transmit and/or a cycle receive-transmit-receive. An uplink-downlink ratio is adjustable on a symbol level in the TDD frame. The TDD frame is partitioned into one or more of a guard period, a downlink portion and an uplink portion. Thus the network apparatus 601 selects the frame format to be applied, and configures data transmission and reception based on said selecting. In item 802, the network apparatus 601 signals information on a selected frame format to at least one network node 602 (which may comprise e.g. a user terminal). In item 803, the network node 602 receives information on a frame format selected in the network apparatus 601 for the user terminal 602. The network node 602 configures, in item 803, data transmission and data reception based on the received information. Thus the network node 602 is able to apply 804 a TDD data frame structure such that a TDD frame has a predefined frame duration defining an uplink-downlink switching point periodicity, the frame duration defining a maximum time in which a half-duplex apparatus performs a cycle transmit-receive-transmit and/or a cycle receive-transmit-receive, wherein an uplink-downlink ratio is adjustable on a symbol level in the TDD frame, wherein the TDD frame is partitioned into one or more of a guard period, a downlink portion and an uplink portion.

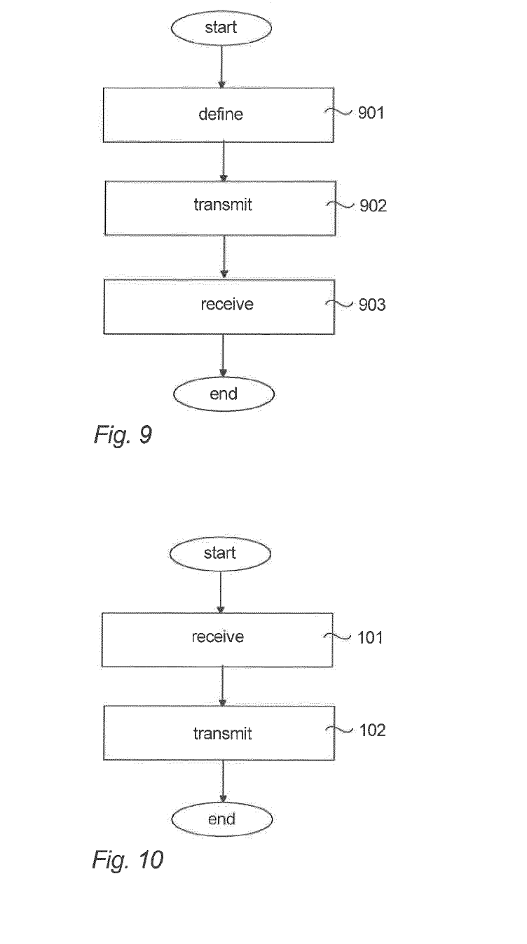

FIG. 9 is a flow chart illustrating an exemplary embodiment. The apparatus 601, which may comprise e.g. an LTE-capable (or LTE-A-capable) base station (eNode-B, eNB) or WLAN access point (AP), predefines, in item 901, a TDD data frame structure such that a TDD frame has a predefined frame duration defining an uplink-downlink switching point periodicity. Thus the frame duration defines a maximum time in which a half-duplex apparatus performs a cycle transmit-receive-transmit and/or a cycle receive-transmit-receive. An uplink-downlink ratio is adjustable on a symbol level in the TDD frame. The TDD frame is partitioned into one or more of a guard period, a downlink portion and an uplink portion. Thus the apparatus 601 selects 901 the frame format to be applied, and configures 901 data transmission and reception based on said selecting. In item 902, the apparatus 601 signals information on the selected frame format to at least one further apparatus 602 which may comprise e.g. a network element (network node, e.g. a user terminal, UE). In item 903, the apparatus 601 may receive data transmitted by the network node 602 applying the selected frame format.

FIG. 10 is a flow chart illustrating an exemplary embodiment. The apparatus 602, which may comprise e.g. a network element (network node, e.g. a user terminal, UE), receives, in item 101, information on a frame format selected in a further apparatus 601 (which may comprise e.g. an LTE-capable (or LTE-A-capable) base station (eNode-B, eNB) or WLAN access point (AP)) for the apparatus 602. The apparatus 602 configures, in item 101, data transmission and data reception based on the received information. Thus the apparatus 602 is able to apply 102 a TDD data frame structure such that a TDD frame has a predefined frame duration defining an uplink-downlink switching point periodicity, the frame duration defining a maximum time in which a half-duplex apparatus performs a cycle transmit-receive-transmit and/or a cycle receive-transmit-receive, wherein an uplink-downlink ratio is adjustable on a symbol level in the TDD frame, wherein the TDD frame is partitioned into one or more of a guard period, a downlink portion and an uplink portion.

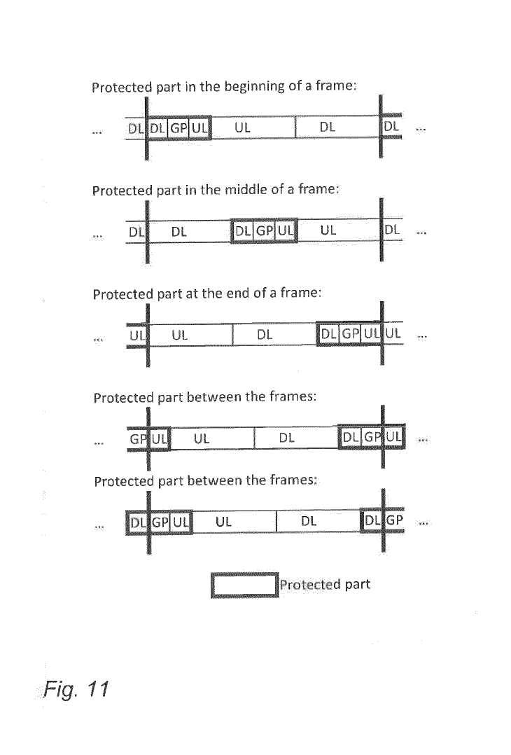

FIG. 11 illustrates a flexible location of the protected part in the frame according to an exemplary embodiment (the protected part is not necessarily located in the beginning of the frame).

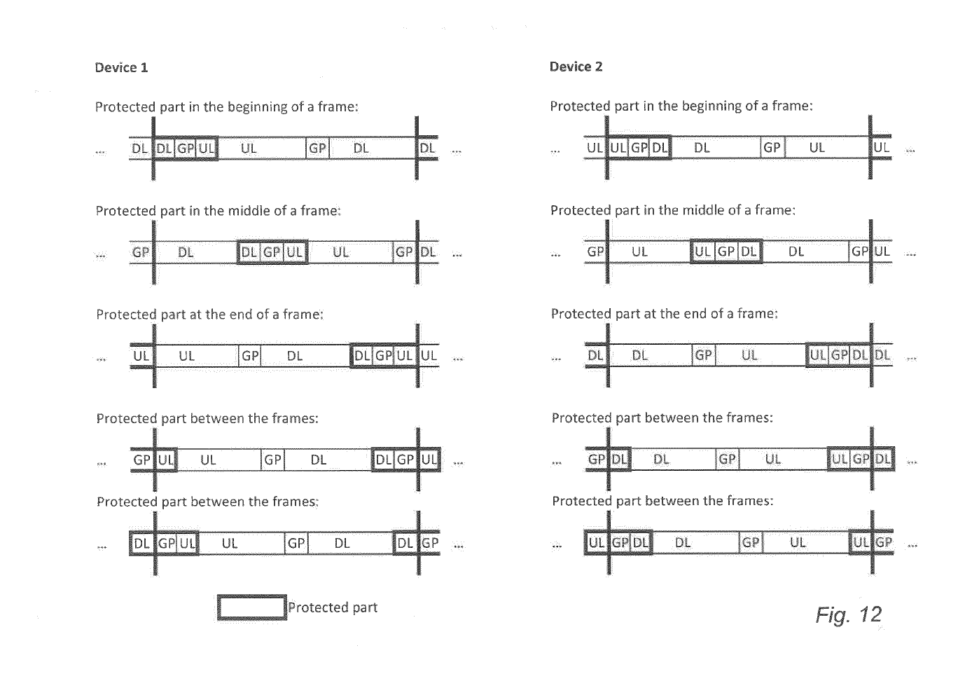

FIG. 12 illustrates a situation where the guard period is drawn to both DL→UL and UL→DL switching points according to an exemplary embodiment.

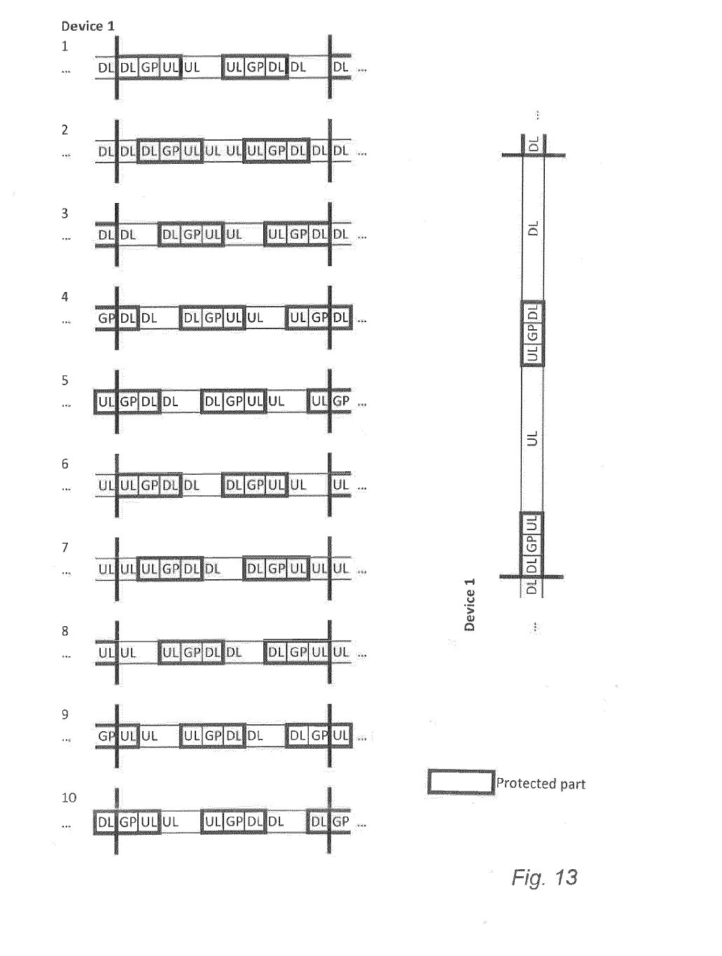

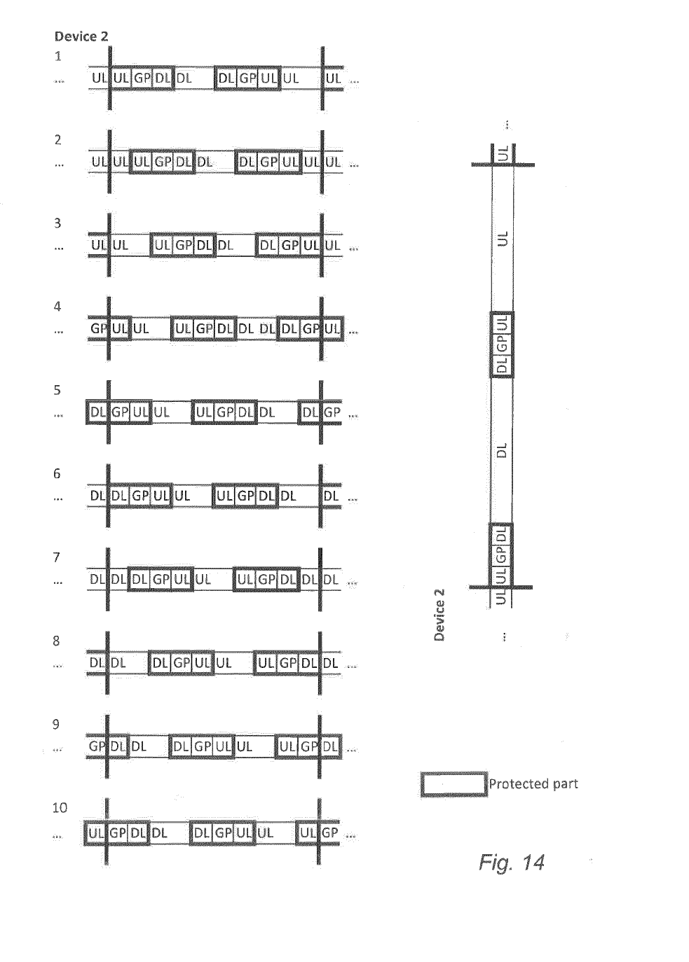

In an exemplary embodiment, it is possible to determine the protected part to be either located at a DL→UL switching point, UL→DL switching point, or both. FIGS. 13 and 14 illustrate a situation with two protected parts in a frame, where the guard periods are drawn to both DL→UL and UL→DL switching points. In an exemplary embodiment, it is possible to configure the sizes of DL and UL portions in the protected part(s) semistatistically. If two protected parts are defined in the frame, the configuration may be different for the two protected parts defined. It may also be possible that the protected part only comprises the DL or UL portion (and GP).

Also other scenarios with protected parts located in different locations in the frame than those presented in FIGS. 11 to 14, are possible. It should be noted that cases 1-5 of “device 1” in FIG. 13 are the same as cases 6-10 of “device 2” in FIG. 14, and vice versa.

The steps/points, signalling messages and related functions described above in FIGS. 1 to 14 are in no absolute chronological order, and some of the steps/points may be performed simultaneously or in an order differing from the given one. Other functions can also be executed between the steps/points or within the steps/points and other signalling messages sent between the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplary and may even comprise several separate messages for transmitting the same information. In addition, the messages may also contain other information.

Thus, according to an exemplary embodiment, there is provided a method for selecting a frame format in a communications system, the method comprising predefining, in a communications apparatus, a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of a guard period, a link direction 2 portion and a link direction 1 portion.

According to another exemplary embodiment, the link direction 2 portion is divided into up to two link direction 2 parts and the link direction 1 portion is divided into up to two link direction 1 parts, wherein a first link direction 2 part is followed by the guard period that is then followed by the link direction 1 portion in the TDD frame.

According to yet another exemplary embodiment, the link direction 1 portion is divided up to two link direction 1 parts and the link direction 2 portion is divided into up to two link direction 2 parts, wherein a first link direction 1 part is followed by the guard period that is then followed by the link direction 2 portion in the TDD frame.

According to yet another exemplary embodiment, the link direction 1 portion is divided up to two link direction 1 parts, wherein a first link direction 1 part is divided up to two further portions, and the link direction 2 portion is divided into up to two link direction 2 parts, wherein a second link direction 2 part is divided up to two further portions, wherein a first further link direction 1 portion is followed by the guard period that is then followed by a first further link direction 2 portion in the TDD frame, wherein a second further direction 2 portion is followed by the guard period that is then followed by a second further link direction 1 portion in the TDD frame.

According to yet another exemplary embodiment, the link direction 1 portion comprises an uplink or reverse link portion, and the link direction 2 portion comprises a downlink or forward link portion.

According to yet another exemplary embodiment, the link direction 1 portion comprises a downlink or forward link portion, and the link direction 2 portion comprises an uplink or reverse link portion.

According to yet another exemplary embodiment, the TDD frame is partitioned into a protected part and a non-protected part, wherein the protected part of the TDD frame includes a first part of the link direction 1 portion, the guard period, and a first part of the link direction 2 portion.

According to yet another exemplary embodiment, the TDD frame is partitioned into a protected part and a non-protected part, wherein the protected part of the TDD frame includes one or more of 1) and 2):

1) a first portion of a first link direction 1 part, the guard period, and a first portion of a first link direction 2 part,

2) a second portion of a first link direction 2 part, the guard period, and a second portion of a first link direction 1 part.

According to yet another exemplary embodiment, the non-protected part includes a second link direction 1 part and a second link direction 2 part.

According to yet another exemplary embodiment, the protected part is configured in a semi-static manner, and an uplink-downlink ratio of the non-protected part is configured dynamically by setting it adaptively in a symbol specific manner.

According to yet another exemplary embodiment, a scalable frame duration is used to allow trade-off between guard period overhead and latency.

According to yet another exemplary embodiment, a scalable guard period length is used to allow trade-off between the guard period and latency.

According to yet another exemplary embodiment, a scalable guard period length is used to allow trade-off between timing advance requirements and latency.

According to yet another exemplary embodiment, there is provided a method comprising defining a frame hierarchy in order to achieve fast and flexible uplink-downlink switching, wherein a master frame is of a normal frame format used in a cell, wherein uplink/downlink division of a protected part of the master frame is followed by each node in the cell, wherein if during an unprotected part of the master frame there is no other data transmission of higher priority, the unprotected part of the master frame is divided into local frames suitable for data transmission of lower priority, a local frame including a local frame specific downlink portion, guard period and uplink portion.

According to yet another exemplary embodiment, there is provided a method comprising applying a frame format on top of an LTE frame structure by defining the frame duration to be 1 ms or 0.5 ms, the communications apparatus having a capability to schedule and assign said frame format, replacing a subframe or slot corresponding to one or more consecutive subframes or slots.

According to yet another exemplary embodiment, there is provided a method comprising carrying out scheduling dynamically or semi-statically based on a predefined pattern of subframes or slots.

According to yet another exemplary embodiment, there is provided a method comprising selecting, in a first transceiver, the frame format to be applied, configuring data transmission and reception based on said selecting, and signalling information on the selected frame format to at least one second transceiver.

According to yet another exemplary embodiment, the TDD frame comprises an uplink-only frame format including an uplink portion, without the guard period and a downlink portion.

According to yet another exemplary embodiment, the TDD frame comprises a downlink-only frame format including a downlink portion, without the guard period and an uplink portion.

According to yet another exemplary embodiment, there is provided an apparatus comprising at least one processor; and at least one memory including a computer program code, wherein the at least one memory and the computer program code are configured to, with the at least one processor, cause the apparatus to predefine, a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of a guard period, a link direction 2 portion and a link direction 1 portion.

According to yet another exemplary embodiment, there is provided an apparatus, wherein the at least one memory and the computer program code are configured to, with the at least one processor, cause the apparatus to configure the protected part in a semi-static manner, and configure the uplink-downlink ratio of the non-protected part dynamically by setting it adaptively in a symbol specific manner.

According to yet another exemplary embodiment, there is provided an apparatus, wherein the at least one memory and the computer program code are configured to, with the at least one processor, cause the apparatus to use a scalable frame duration to allow trade-off between guard period overhead and latency.

According to yet another exemplary embodiment, there is provided an apparatus, wherein the at least one memory and the computer program code are configured to, with the at least one processor, cause the apparatus to use a scalable guard period length to allow trade-off between the guard period and latency.

According to yet another exemplary embodiment, there is provided an apparatus, wherein the at least one memory and the computer program code are configured to, with the at least one processor, cause the apparatus to use a scalable guard period length to allow trade-off between timing advance requirements and latency.

According to yet another exemplary embodiment, there is provided an apparatus, wherein the at least one memory and the computer program code are configured to, with the at least one processor, cause the apparatus to define a frame hierarchy in order to achieve fast and flexible uplink-downlink switching, wherein a master frame is of a normal frame format used in a cell, wherein uplink/downlink division of a protected part of the master frame is followed by each node in the cell, wherein if during an unprotected part of the master frame there is no other data transmission of higher priority, the unprotected part of the master frame is divided into local frames suitable for data transmission of lower priority, a local frame including a local frame specific downlink portion, guard period and uplink portion.

According to yet another exemplary embodiment, there is provided an apparatus, wherein the at least one memory and the computer program code are configured to, with the at least one processor, cause the apparatus to apply a frame format on top of an LTE frame structure by defining the frame duration to be 1 ms or 0.5 ms, the apparatus having a capability to schedule and assign said frame format, replacing a subframe or slot corresponding to one or more consecutive subframes or slots.

According to yet another exemplary embodiment, there is provided an apparatus, wherein the at least one memory and the computer program code are configured to, with the at least one processor, cause the apparatus to carry out scheduling dynamically or semi-statically based on a predefined pattern of subframes or slots.

According to yet another exemplary embodiment, there is provided an apparatus, wherein the at least one memory and the computer program code are configured to, with the at least one processor, cause the apparatus to select a frame format to be applied, configure data transmission and reception based on said selecting, and signal information on the selected frame format to at least one network node.

According to yet another exemplary embodiment, there is provided a user equipment comprising at least one processor; and at least one memory including a computer program code, wherein the at least one memory and the computer program code are configured to, with the at least one processor, cause the user equipment to apply a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of a guard period, a link direction 2 portion and a link direction 1 portion.

According to yet another exemplary embodiment, there is provided a user equipment, wherein the at least one memory and the computer program code are configured to, with the at least one processor, cause the user equipment to receive information on a frame format selected in a network apparatus, and configure data transmission and data reception based on said selecting.

According to yet another exemplary embodiment, there is provided a computer program product comprising program code means adapted to perform any one of the method steps when the program is run on a computer.

It will be obvious to a person skilled in the art that, as the technology advances, the inventive concept can be implemented in various ways. The invention and its embodiments are not limited to the examples described above but may vary within the scope of the claims.

List of Abbreviations

AP access point

CP cyclic prefix

CTS clear-to-send

D2D device to device

AP2AP access to access point

DL downlink

DwPTS downlink pilot time slot

eNB enhanced node-B

FDD frequency division duplexing

GP guard period

LTE long term evolution

LTE-A LTE-advanced

RTS ready-to-send

RTT round trip time

TCP transmission control protocol

TDD time division duplexing

UE user equipment

UL uplink

UpPTS uplink pilot time slot

TTI transmission time interval

TD time division

OFDMA orthogonal frequency division multiple access

HARQ hybrid automatic repeat request

WLAN wireless local area network

tx transmitter

rx receiver

1. A method for selecting a frame format in a communications system, the method comprising:
predefining, in a communications apparatus, a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive,
wherein a link direction 1-link direction 2 ratio is adjustable on a symbol level in the TDD frame,
wherein the TDD frame is partitioned into one or more of a guard period, a link direction 2 portion and a link direction 1 portion.

2. A method according to claim 1, further comprising dividing the link direction 2 portion into up to two link direction 2 parts and the link direction 1 portion into up to two link direction 1 parts,
wherein a first link direction 2 part is followed by the guard period that is then followed by the link direction 1 portion in the TDD frame.

3. A method according to claim 1, further comprising dividing the link direction 1 portion up to two link direction 1 parts and the link direction 2 portion into up to two link direction 2 parts,
wherein a first link direction 1 part is followed by the guard period that is then followed by the link direction 2 portion in the TDD frame.

4. A method according to claim 1, further comprising dividing
the link direction 1 portion up to two link direction 1 parts, wherein a first link direction 1 part is divided up to two further portions, and
the link direction 2 portion into up to two link direction 2 parts, wherein a first link direction 2 part is divided up to two further portions,
wherein a first further link direction 1 portion is followed by the guard period that is then followed by a first further link direction 2 portion in the TDD frame,
wherein a second further direction 2 portion is followed by the guard period that is then followed by a second further link direction 1 portion in the TDD frame.

5. A method according to claim 1, wherein the link direction 1 portion comprises an uplink or reverse link portion, and the link direction 2 portion comprises a downlink or forward link portion.

6. A method according to claim 1, where the link direction 1 portion comprises a downlink or forward link portion, and the link direction 2 portion comprises an uplink or reverse link portion.

7. A method according to claim 1, further comprising portioning the TDD frame into a protected part and a non-protected part, wherein the protected part of the TDD frame includes a first part of the link direction 1 portion, the guard period, and a first part of the link direction 2 portion.

8. A method according to claim 1, further comprising portioning the TDD frame into a protected part and a non-protected part, wherein the protected part of the TDD frame includes one or more of 1) and 2):
1) a first portion of a first link direction 1 part, the guard period, and a first portion of a first link direction 2 part,
2) a second portion of a first link direction 2 part, the guard period, and a second portion of a first link direction 1 part.

9.-17. (canceled)

18. A method according to claim 1, wherein the TDD frame comprises at least one of the following:
an uplink-only frame format including an uplink portion, without the guard period and a downlink portion, and
a downlink-only frame format including a downlink portion, without the guard period and an uplink portion.

19. (canceled)

20. An apparatus, comprising
at least one processor; and
at least one memory including a computer program code, the at least one memory and the computer program code are configured to, with the at least one processor, cause the apparatus to
predefine, a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of a guard period, a link direction 2 portion and a link direction 1 portion.

21. An apparatus according to claim 20, wherein the link direction 2 portion is divided into up to two link direction 2 parts and the link direction 1 portion is divided into up to two link direction 1 parts, wherein a first link direction 2 part is followed by the guard period that is then followed by the link direction 1 portion in the TDD frame.

22. An apparatus according to claim 20, wherein the link direction 1 portion is divided up to two link direction 1 parts and the link direction 2 portion is divided into up to two link direction 2 parts, wherein a first link direction 1 part is followed by the guard period that is then followed by the link direction 2 portion in the TDD frame.

23. An apparatus according to claim 20, wherein the link direction 1 portion is divided up to two link direction 1 parts, wherein a first link direction 1 part is divided up to two further portions, and the link direction 2 portion is divided into up to two link direction 2 parts, wherein a first link direction 2 part is divided up to two further portions, wherein a first further link direction 1 portion is followed by the guard period that is then followed by a first further link direction 2 portion in the TDD frame, wherein a second further direction 2 portion is followed by the guard period that is then followed by a second further link direction 1 portion in the TDD frame.

24. An apparatus according to claim 20, wherein the link direction 1 portion comprises an uplink or reverse link portion, and the link direction 2 portion comprises a downlink or forward link portion.

25. An apparatus according to claim 20, wherein the link direction 1 portion comprises a downlink or forward link portion, and the link direction 2 portion comprises an uplink or reverse link portion.

26. An apparatus according to claim 20, wherein the TDD frame is partitioned into a protected part and a non-protected part, wherein the protected part of the TDD frame includes a first part of the link direction 1 portion, the guard period, and a first part of the link direction 2 portion.

27. An apparatus according to claim 20, wherein the TDD frame is partitioned into a protected part and a non-protected part, wherein the protected part of the TDD frame includes one or more of 1) and 2):
1) a first portion of a first link direction 1 part, the guard period, and a first portion of a first link direction 2 part,
2) a second portion of a first link direction 2 part, the guard period, and a second portion of a first link direction 1 part.

28.-36. (canceled)

37. An apparatus according to claim 20, wherein the TDD frame comprises at least one of the following:
an uplink-only frame format including an uplink portion, without the guard period and a downlink portion, and
a downlink-only frame format including a downlink portion, without the guard period and an uplink portion.

38. (canceled)

39. A user equipment comprising
at least one processor; and
at least one memory including a computer program code,
the at least one memory and the computer program code are configured to, with the at least one processor, cause the user equipment to
apply a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of a guard period, a link direction 2 portion and a link direction 1 portion.

40. A user equipment according to claim 39, wherein the at least one memory and the computer program code are configured to, with the at least one processor, cause the user equipment to
receive information on a frame format selected in a network apparatus, and configure data transmission and data reception based on said selecting.

41. (canceled)

42. A method, comprising:
receiving, by a user equipment, information on a frame format selected in a network apparatus;
configuring data transmission and data reception based on said selected frame format, and
applying a TDD data frame structure such that a TDD frame has a predefined frame duration defining a link direction 1-link direction 2 switching point periodicity, the frame duration defining a maximum time in which a half-duplex apparatus performs a cycle transmit-receive-transmit and/or a cycle receive-transmit-receive, wherein a link direction 1-link direction 2 ratio is adjustable on a symbol level in the TDD frame, wherein the TDD frame is partitioned into one or more of the guard period, a link direction 2 portion and a link direction 1 portion.
